(19) United States
(12) Patent Application Publication
(10) Pub. No.: US 2005/0197933 A1
(43) Pub. Date: Sep. 8, 2005

(54) System and Method for Processing Asset Information from multiple sources and Distributing in Asset Information in Digital Format for Insurance and Financial coverage

(75) Inventors: Michael Jason Ullom, Mason, OH (US); Paul Robert Tanner, Lebanon, OH (US); Reuben Earl Oder III, Lebanon, OH (US); Erica Heidi Hollman, Kenosha, WI (US); Nancy Coultrip Dawes, Cincinnati, OH (US); Debra Gay Gehring, Cincinnati, OH (US); Karl Anton Bakker, Chicago, IL (US); Ty Eric Martin, Loveland, OH (US); Peter James Hargraves, Cincinnati, OH (US); Tanya Nicole Blasko, Cincinnati, OH (US)

Correspondence Address: Patricia Sheehan Robison, 214 W 16th St. 1-W, New York, NY, 10011, US

(73) Assignee: Ms. Patricia Sheehan Robison, New York, NY (US)

(21) Appl. No.: 10/708,473

(22) Filed: Mar. 5, 2004

(51) Int. Cl. G06F 17/60

(52) U.S. Cl. 705/35; 705/38

(57) ABSTRACT

A system for processing asset information received from multiple sources, and distributing asset information in digital format for use by the insurance and financial institutions. The asset processing system includes the acquisition and processing of asset data received from video, digital images, scanned images, audio files, agency management systems, asset tracking systems, messaging interfaces and user input. The asset processing system streamlines and enhances the existing manual and disconnected asset information gathering methods. The asset processing system distributes asset information in standard digital format to multiple entities including insurance companies and other financial institutions.

### BACKGROUND OF INVENTION

This invention relates to a system and method for processing asset information from multiple sources and distributing asset information in digital format for insurance and financial coverage.

The process of getting insurance on coverage on assets for private clients and businesses typically involves a number of parties. The owner of the assets must meet with a broker or producer to determine the type and amount of coverage that the insured is considering for the assets. Second, the broker must interact with an insurer or carrier to write a policy for the insured. The process has historically involved a lot of effort in collecting the proper information about the assets.

The manual and semi-automated processes are being replaced by a computer system that processes asset information received from multiple sources and distributes asset information in digital format to insurance and other financial processes.

### SUMMARY OF INVENTION

The present innovation establishes a standard system and method for processing asset information received from multiple sources and then distributing asset information in digital format for use by the insurance industry as well as other financial service organizations.

The present invention includes a process to acquire, deconstruct, and associate asset information received from multiple sources, and then to distribute the asset information in digital format.

The optimal implementation of this method includes a system to receive any digital information on the assets that is supplemented by a manual process to digitize the information when required. The most efficient implementation solution includes a connection to the Internet for interaction by producers, insurance carriers, and other asset information processing companies.

The asset acquisition system receives information on the assets in digital format where possible, paper forms where necessary, and through data entry screens. A processing component of the system takes the digital information and deconstructs and re-aggregates when required into a form for processing. Another component of the system transforms information on paper or photographs for use in association. The system includes a database that is used to store the acquisition and associated information. And the distribution component takes the asset information and produces messages for distribution to multiple parties in the process.

### BRIEF DESCRIPTION OF DRAWINGS

FIG. 1A is a schematic block diagram of the asset information processing distribution system FIG. 1B is a more detailed connectivity configuration for the asset information processing and distribution system.

FIG. 1C shows possible configuration connections of the insurance company, an asset tracking system, and a broker agency with an agency management system.

FIG. 2 shows a detailed breakdown of a basic asset processing and distribution system configuration on an internal network FIG. 3 shows server hardware configuration FIG. 4 illustrates one configuration of the memory constructed according to the present invention for the asset information acquisition server FIG. 5 illustrates one configuration of the memory constructed according to the present invention for the asset information aggregation server.

FIG. 6 illustrates one configuration of the memory constructed according to the present invention for the asset information distribution server.

FIG. 7 shows the acquisition method for processing asset information FIG. 8 illustrates the aggregation method for processing asset information FIG. 9 shows the video deconstruction process in detail FIG. 10 Digital Asset Information Distribution Method

### DETAILED DESCRIPTION

A method and system for processing asset information received from multiple sources and distributing asset information in digital format for insurance and financial coverage is described below. The asset information processes that the system offers includes asset information acquisition, deconstruction, association and distribution. This system is directed at insurance carriers and the producers as part of the policy processing as well as other financial institutions, (e.g. trust companies) that process asset information. The system includes, but is not excluded to, the processing of asset information for commercial asset coverage (e.g. inland marine) as well as asset private client asset coverage (e.g. property).

The detailed presentation includes descriptions in terms of algorithms of operations on data bits within the memory of a computer. An algorithm is generally defined to be a self-consistent sequence of steps leading to a desired result. These steps require manipulations of quantities. Usually these quantities take the form of magnetic signals capable of being stored, manipulated, transferred, and combined. Terms such as computing or calculating refer to the action and processes of a computer system that manipulates and transforms data represented as electrical signals within computer systems memories or data storage devices.

The present invention also relates to the equipment for performing the operations herein. The equipment may be a general-purpose computer selectively configured by a hardware/software professional. The algorithms are maintained in computer programs. The computer programs are stored on computer storage devices that include floppy disk, optical disks, read-only memories, random access memories, magnetic cards, and video input devices.

The algorithms presented herein are not inherently relegated to any particular computer or to the equipment. Various general-purpose systems may be used with programs described herein in conjunction with other programs. In addition, the present invention is not described with reference to any particular programming language. A variety of programming languages may be used to implement the invention herein.

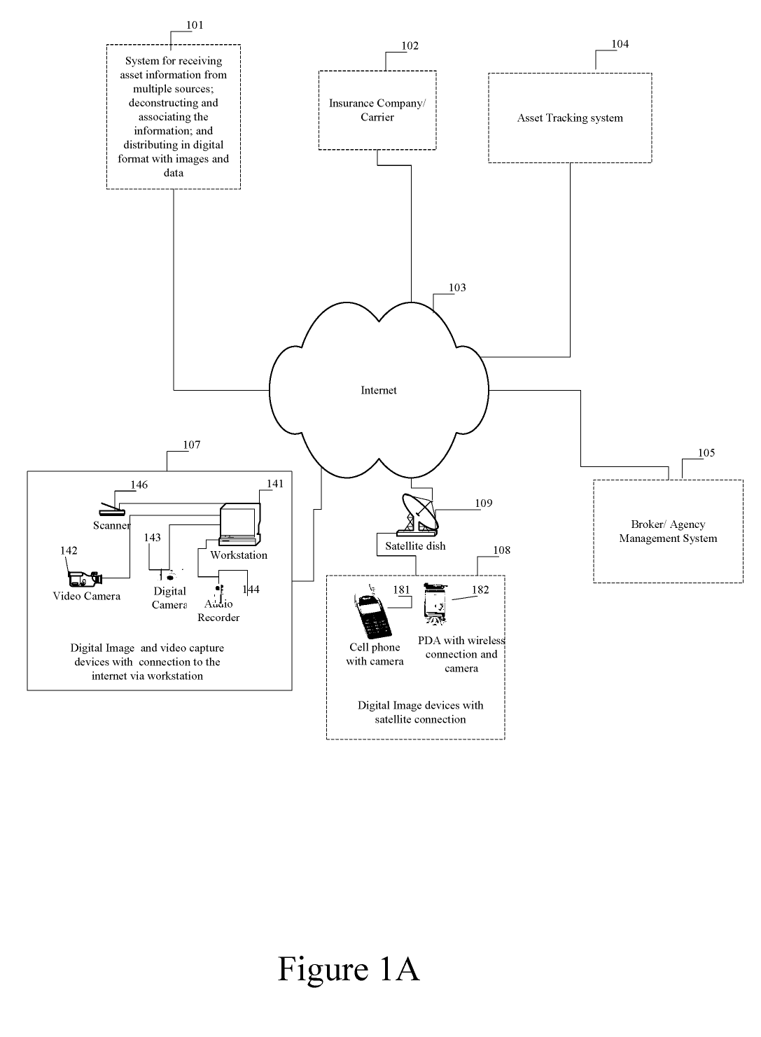

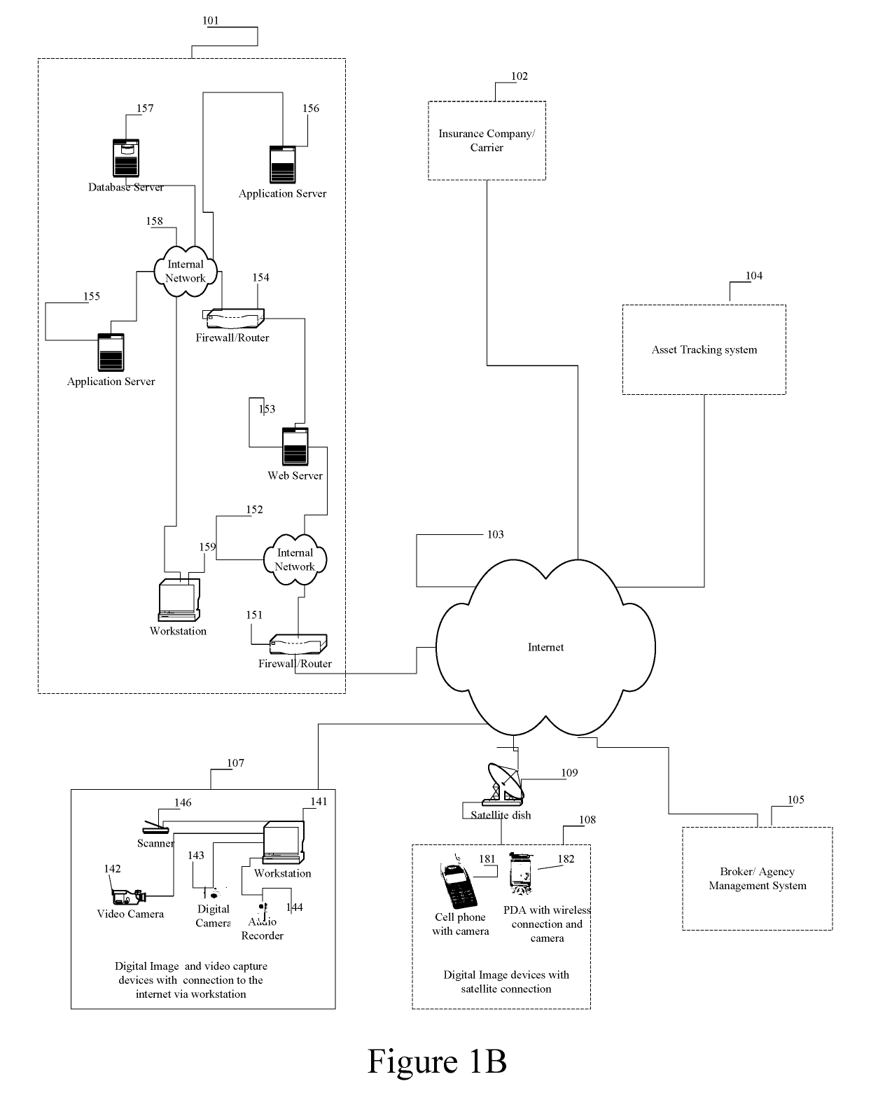

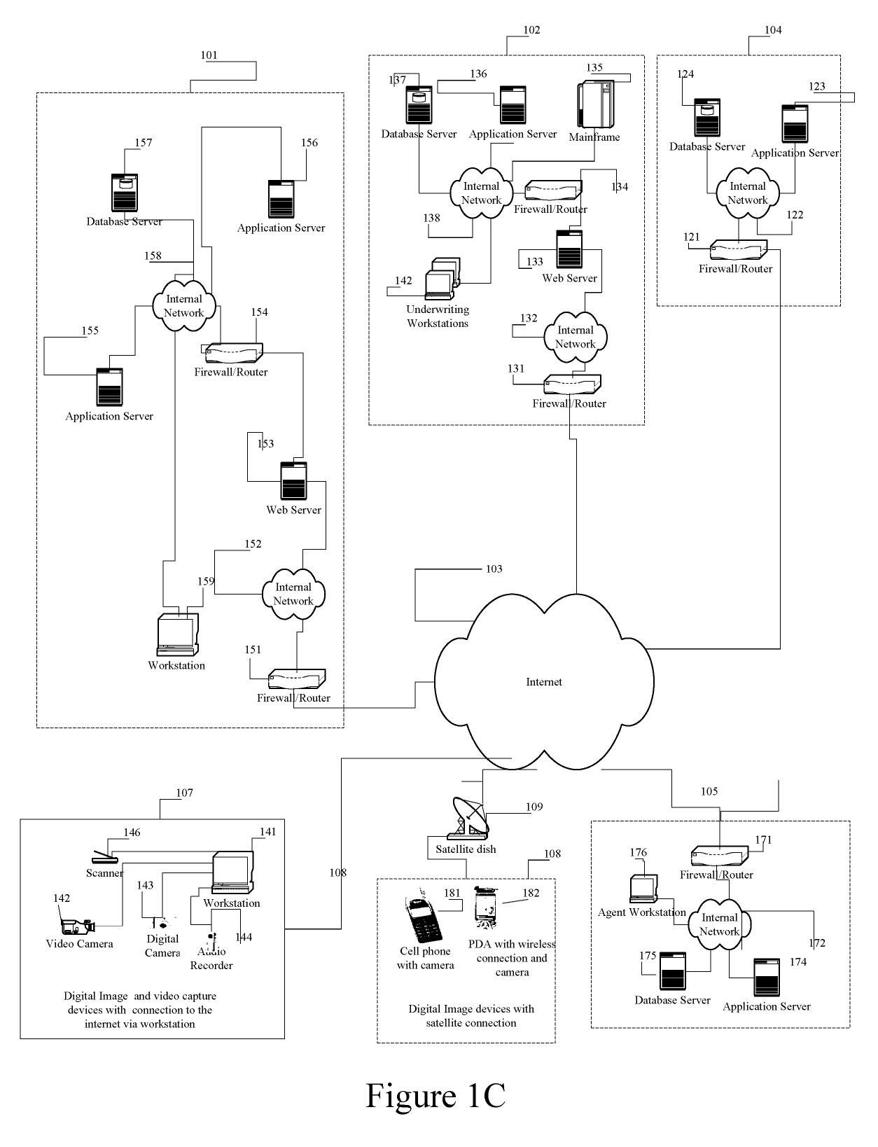

1. System Overview FIG. 1A illustrates a system for processing asset information received from multiple sources and then distributing asset information in digital format for use by the insurance industry as well as other financial service organizations. The system comprises an asset information processing and distribution system 101, a broker/agency management system 105, an asset tracking system 104, digital image devices with satellite connections 104, and video, image and audio capture devices connected to a workstation. implemented on a network such as the Internet 103. Even though only one insurer system is shown, any number of insurer systems connected to the Internet could be implemented in this configuration.

The asset information processing and distribution system 101 operates in conjunction with a secured user 107 (e.g. a broker, asset information collector) to allow submission of the asset information. The broker enters information into screens or from devices that they have gathered from the potential insured. The system interoperates with existing systems that hold asset information for the insured. The system allows for the receipt of information from an agency management system 105 or potentially an asset tracking system 107 (e.g. Instant Data Systems Mobility Suite) containing asset information for the potential insured.

A secured access point 107 could be used directly by the potential insured to submit information about their assets. The system also allows for transmission via satellite communications 109 from a digital image wireless device 108 including cell phones with cameras 181 or pdas with wireless connections and a camera 182.

FIG. 1B illustrates more detailed connectivity configuration for the asset information processing and distribution system. 101. The diagram shows the basic components of the system including a firewall/router connected to the first area of the internal network 152, connected to a web server 153, which is then connected a second router 154. This layer of initial connectivity is not required but provides greater security than if the web server is hosted on inner most internal network 158. The application servers 156 and 156 may be combined or distributed depending on the size of the system which is based on the number of assets that are processed, the complexity of the information, and the amount of high processing content for deconstruction including video processing. The database server 157 is separated to support dedicated database processing. These servers are discussed in more detail in subsequent sections.

FIG. 1C shows possible configuration connections of the insurance company 102, an asset tracking system 104, and a broker agency with an agency management system 105. In this configuration example the insurance carrier has a firewall/router 131 connected to the first internal network 132 that is subsequently connected to a web server 133. A second firewall/router 134 provides secure access to the internal network area 138, which connects underwriting workstations 142, application servers 136, database servers 137, and mainframe systems 135. The example of the asset tracking system 104 that could be hosted at a client site or remotely shows a firewall router 121 providing access to an internal network 122, which connects to the application server 123 and a database server 124. The agency management system 103 shows a configuration where a firewall/router 171 controls access to an internal network 172 that connects agent workstations 176, a database server 175, and an application server 174. These are just possible examples of implementations. Configurations will vary widely depending on the size of the carrier and the types of systems used.

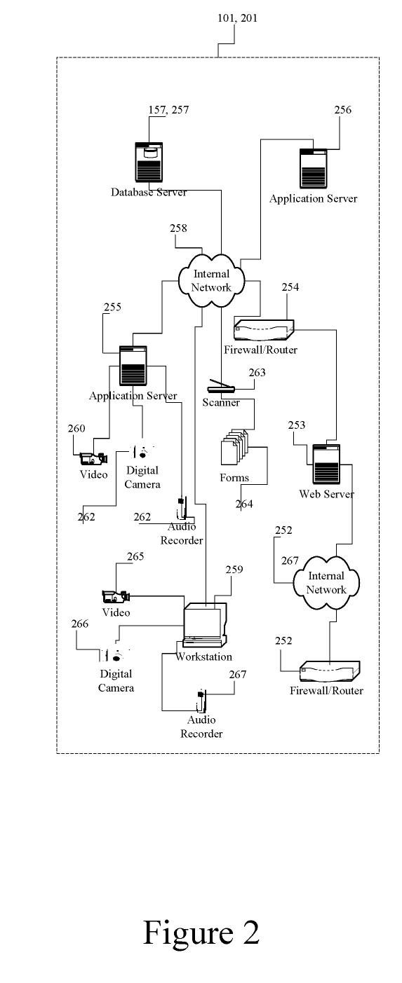

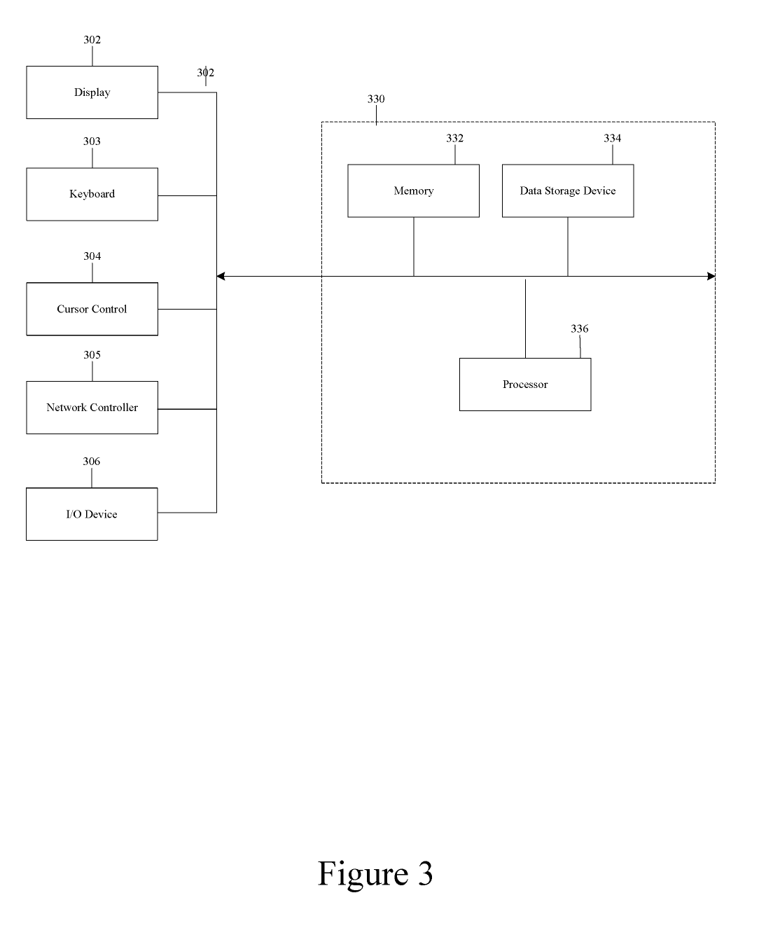

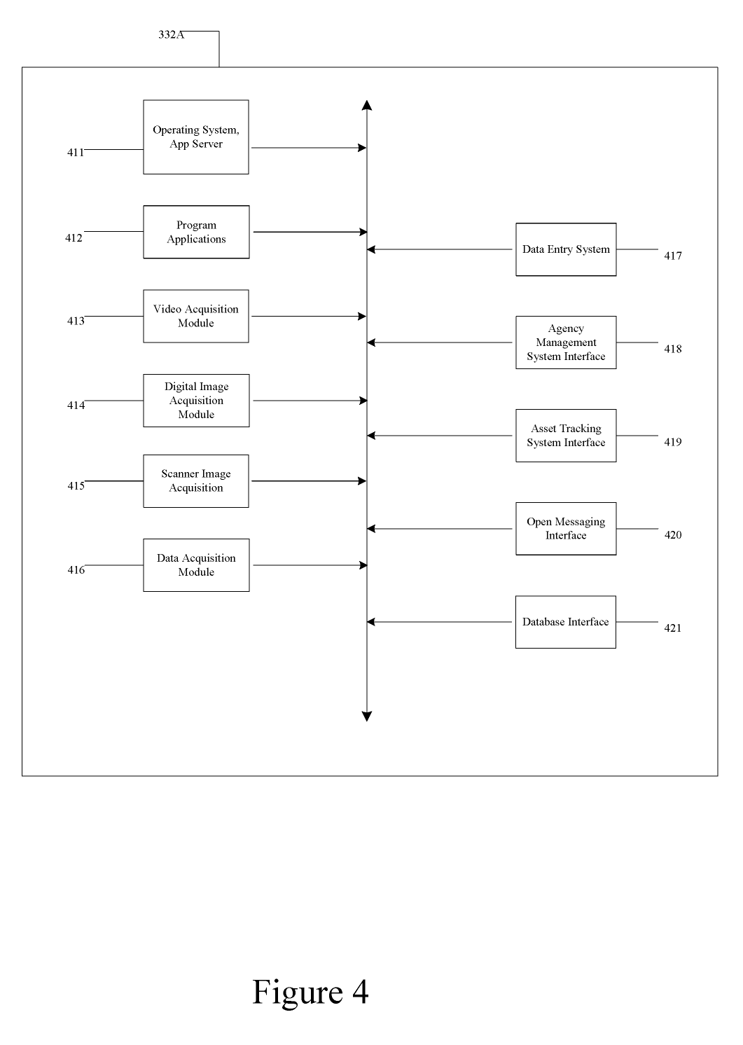

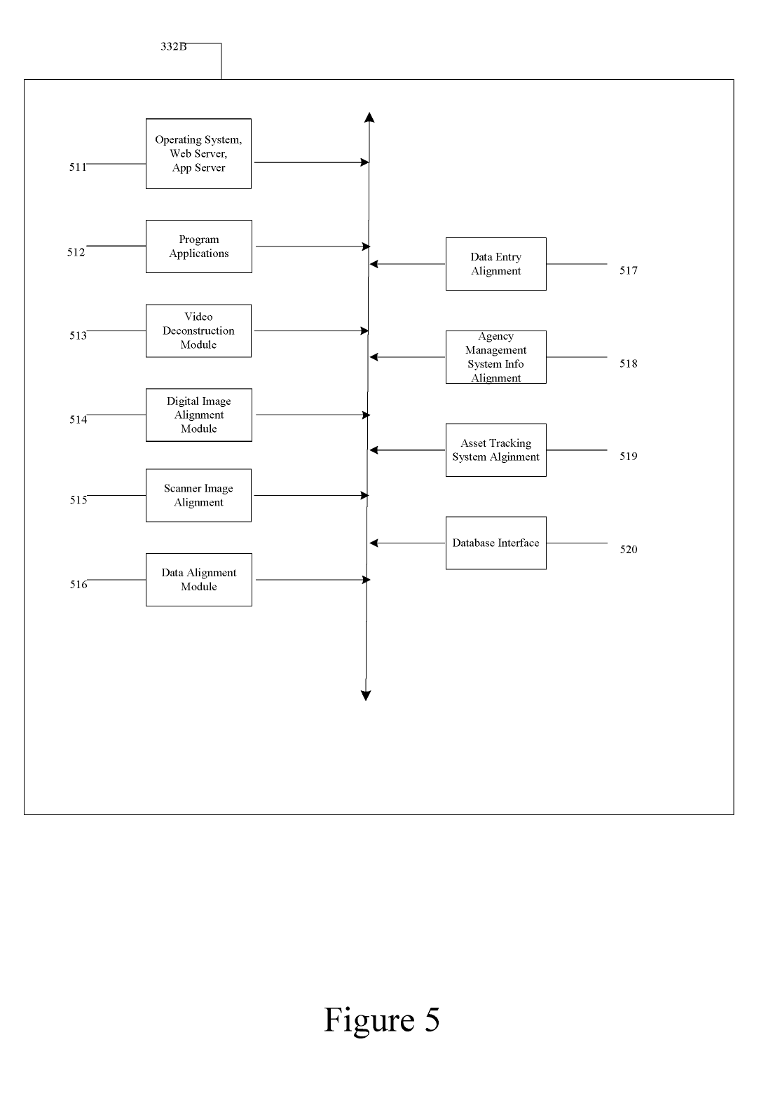

2. Physical Network Configuration and Connectivity of key components FIG. 2 shows a detailed breakdown of a basic asset processing and distribution system 101, 201 configuration on an internal network. The key components are the firewall/routers 252, 254, the webserver 253, the application Servers 255, 256, the database server 257 and digital video, image and audio devices 267, 266, 265.

The firewall 252, 254 includes a set of related programs and hardware located at the networks gateway or initial access point to protect the resources within the network. The router includes programs and hardware that determines which way to send information packets on the network.

Application Servers The application servers 255, 256 include the hardware, the operating system, and the programs to process the logic described herein. The physical configuration of the application servers is described in more detail in the subsequent section. The application server operating system can be based on Microsoft Windows® 2000 Server® or any UNIX® implementation including Solaris®, AIX®, or LINUX®. The application server software to support application processing can be based on Windows 2000 Server®, WebSphere®, BEA WebLogic®, JBOSS®, or any application server software that supports the program logic processing in a multi-user environment.

The illustration depicts an application server 255 dedicated for asset information acquisition. This application server 255 supports digital input devices including a video camera 260, a digital camera 262, and a digital audio recording device 263.

As shown in FIG. 2 a preferred configuration includes a second application server 26 to support the asset information aggregation and asset information distribution module. The application server supporting these modules does not need to have the additional support for video, audio and image input.

Database servers The FIG. 2 also shows a dedicated database server 257 to support database applications. This database server 257 includes an operation system (e.g. Windows 2000®, Windows Net®, UNIX®, AIX®, LINUX®) as well as a database specialized application such as Oracle®, MySQL®, or UDB®.

Web Servers FIG. 2 shows the web server 253 which includes an operating system as well as web server specialized programs such as TomCat, IBM WebSphere http server, Windows IIS server, etc. The webserver is primarily dedicated to supporting interaction from the internet and processing of display and interaction support. The webserver software and capabilities can be implemented on the application software but this will result in reduced performance and security.

Workstation FIG. 2 also shows a workstation 259 that is dedicated to receiving and processing asset information. The internal network connected workstation interfaces to video cameras 262, digital cameras 266, digital audio recorders 267, and indirectly to scanners 263 to support paper form 264 inputs.

3. Basic Server Hardware Configuration The server configurations 110,120 will now be described in more detail as shown in FIG. 3. The servers have common hardware configurations with add on physical components for specific purposes. As shown in FIG. 3, the basic server includes a processor, memory 332, a display device 302, a keyboard 303, a cursor control device 304, I/O devices 306, and a network controller 305, coupled together by a bus 302.

The processor 336 processes data signals and generally is configured using a complex instruction set computer (CISC), a reduced instruction set computer (RISC), or a combination of instruction sets.

The data and/or instructions are stored in the memory 332. The processor 336 executes the data and/or instructions. The instructions may include programming code that contains the methods described herein. Memory 332 may be in the form of dynamic random access memory (DRAM) or static access memory (SRAM) or other memory devices known in the art.

The display device 302 may include any device that is capable of displaying electronic images and data described herein. Examples of such display devices include a cathode ray tube (CRT), a liquid crystal display (LCD), or any other device equipped with a screen or monitor.

The keyboard device 303 includes an input device for alphanumerics. The cursor control 304 device represents a user input device that communicates positional data as well as command selection. The cursor control includes a mouse, trackball or other devices supporting cursor movement.

The I/O devices 306 include devices equipped to receive and transmit audio and video to external devices. Audio input may originate from a microphone or from an audio device such as an audio recorder. Video input may originate from a digital video device such as a digital recorder or from an analog device where the I/O device would include an analog/digital converter.

Data storage devices 334 store instructions and data for the processor. The data storage devices include a hard disk drive, a floppy disk drive, a CD ROM device, a DVD-rom, a DVD ram, a DVD RW device, a flash memory device, or other mass storage devices known in the art.

A.Asset Information Acquisition Server FIG. 4 illustrates one configuration of the memory 332A constructed according to the present invention. The memory includes an operating system and application server 411, program applications 412, a video acquisition module 413, a digital image acquisition module 414, a scanner image acquisition module 415, a data acquisition 416, a data entry system 417, an agency management system interface 418, an asset tracking system interface 419, an open messaging interface 420, and a database interface connected to the bus 302.

The memory 332A configuration includes an operating system and an application server 411. The operating system may be based on WINDOWS®, LINUX®, OR UNIX®. The application server may be based on an application server such as WINDOWS IIS. IBM's WebSphere Application Server®, BEA's WebLogic Application Server®, JBOSS® or any application server that supports module application interoperability.

The program application server module is coupled to the collection of modules 413, 414, 415, 416, 417, 418, 419, 420 and 421. The program application module supports the framework for module operations. In one embodiment of the invention the video acquisition module 413 receives a video stream and the program application module supports the passing and storage of the video stream to the database interface 421. In another implementation the program application server supports the user interface for a data entry system 417 to display a series of screens that captures data and sends the information through the database interface 421 to the database server.

The digital image acquisition module 414 is coupled to the program application module to support the receipt of digital images and the pass through of these images to the database interface for storage. The scanner image acquisition module 415 supports the receipt of scanned images for pass through to the database interface for storage. The data acquisition module 416 allows for data receipt through standard data acquisition and messaging systems for the receipt of data on a message bus that is then passed through to the database interface. The agency management system interface 418 is may be tailored to work with one of the existing agency management systems for the receipt of data that is then passed through to the database interface. The asset tracking system interface 419 works in a similar manner in that it may be customized to work with a specific asset tracking system to receive data and pass it through to the database interface. The open messaging interface 420 is a module to support standard xml messaging between any system that supports such open messaging interfaces, so that the messaging are received and then passed through to the database interface 421.

Asset Information Aggregation Server FIG. 5 illustrates one configuration of the memory 332B constructed according to the present invention. The memory includes an operating system, and application server 511, program applications 512, a video deconstruction module 513, a digital image alignment module 514, a scanner image deconstruction module 515, a data/messaging alignment module 516, a data entry alignment system 517, an agency management system alignment module 518, an asset tracking system alignment module 519, and a database interface 520 connected to the bus 302.

The memory 332B configuration includes an operating system and an application server 411. The operating system may be based on Windows XP Server®, LINUX®, OR UNIX®. The application server may be based on an application server such as Windows NET, IBM's WebSphere Application Server®, BEA's WebLogic Application Server®, JBOSS® or any application server that supports module application interoperability.

The program application server module is coupled to the collection of modules 512, 513, 514, 515, 516, 517, 518, 519, and 520. The program application module 512 supports the framework for module operations. In one embodiment of the invention the video deconstruction acquisition module 512 processes the video file that has been previously received and stored in the acquisition database. The program module 512 supports the passing and storage of the deconstructed image and data files from the video files to the database interface 520. In another implementation the program application server supports the user interface for a data entry alignment 517 to display a series of screens that supports the alignment of data captured in the data entry acquisition module to image and data that is processed in the aggregation process.

The digital image alignment module 514 is coupled to the program application module to support the alignment of images to data asset information, which is then processed through the database interface 520. The scanner image deconstruction module 515 is coupled with the program application to enable the deconstruction of the scanned images stored previously in the acquisition database. Scanned images are deconstructed into digital images and data, and the information is aligned and then stored in the aggregation database by means of the database interface 520.

The data/messaging alignment module 516 operates in conjunction with the program applications to process the data and messages received and stored previously in the acquisition database. The data and/or messages are deconstructed to delineate the images and asset data and then aligned and stored in the aggregation database by means of the database interface 520.

The agency management system information alignment module 518 processes the information previously received from agency management systems and stored in the acquisition database. The information is deconstructed into images and data; and then aligned and stored in the aggregation database through the database interface 520.

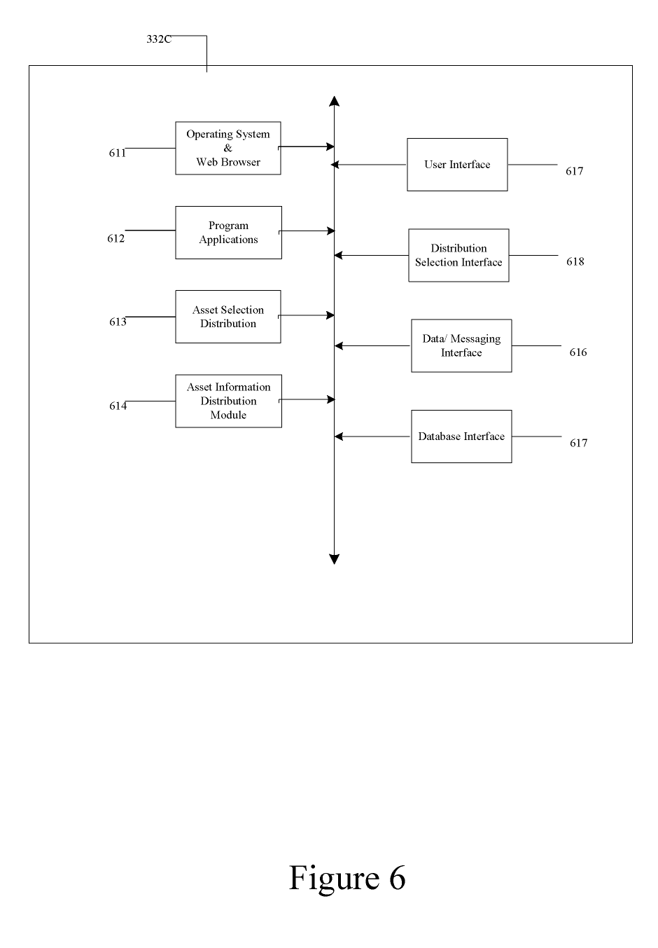

The program application module 512 supports the asset tracking system alignment module 519, which processes the information, previously received from agency management systems and stored in the acquisition database. The information is deconstructed into images and data; and then aligned and stored in the aggregation database through the database interface 520.interface Asset Information Distribution Server FIG. 6 illustrates one configuration of the memory 332C constructed according to the present invention. The memory includes an operating system, and application server 611, program applications 612, an asset selection distribution module 613, an asset information distribution module 616, a user interface module 617, and a database interface module 619.

The memory 332C configuration includes an operating system and an application server 611. The operating system may be based on Windows 0.2000®, LINUX®, OR UNIX®. The application server may be based on an application server such as WINDOWS Net®, IBM's WebSphere Application Server®, BEA's WebLogic Application Server®, JBOSS® or any application server that supports module application interoperability.

The program application server module is coupled to the collection of modules 612, 613, 614, 615, 616, 617, 618, 619, and 620. The program application module supports the framework for module operations. In one embodiment of the invention the asset selection distribution module supports asset selection prompted by a user from the user interface 617 process that identifies the asset image and data information that has to be sent from the database interface 620. The distribution site selection module 618 supports the user selection of distribution sites and initiates the distribution of the information. The data/messaging interface supports the distribution of the asset image and data information 619 to the based on the asset selections and destinations.

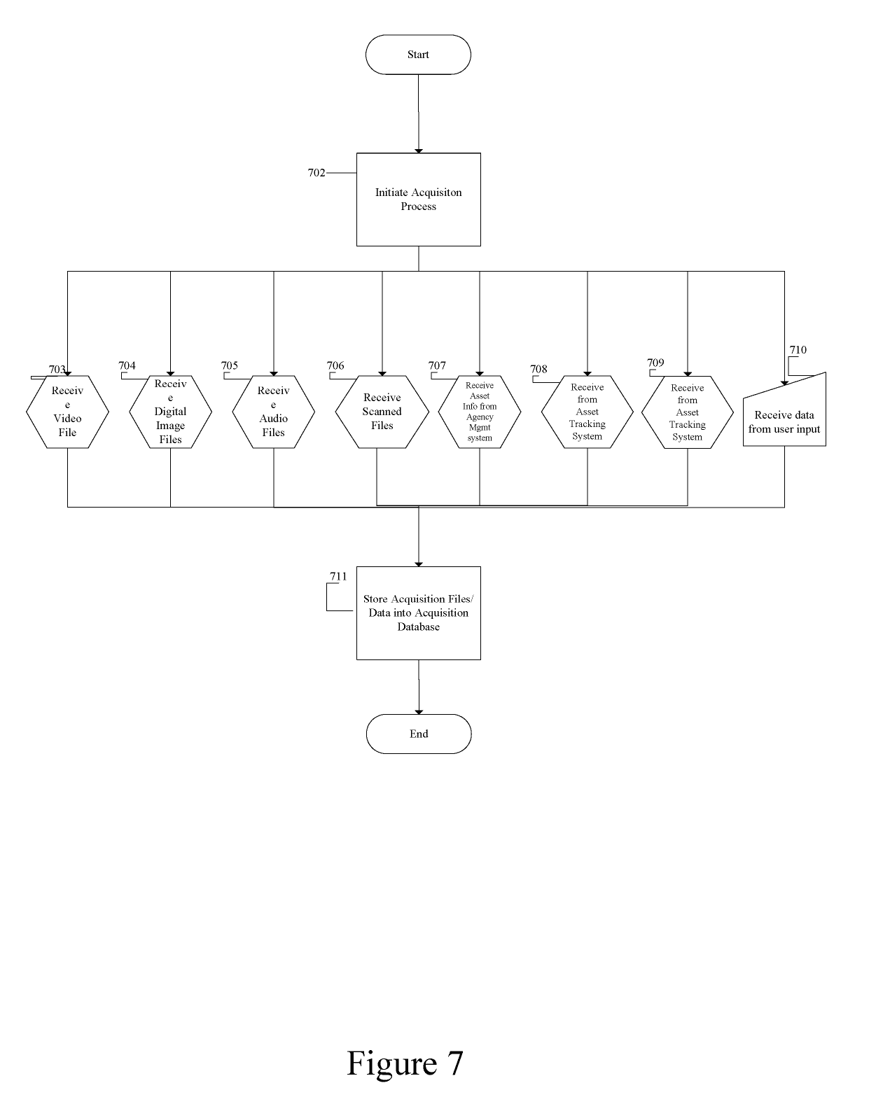

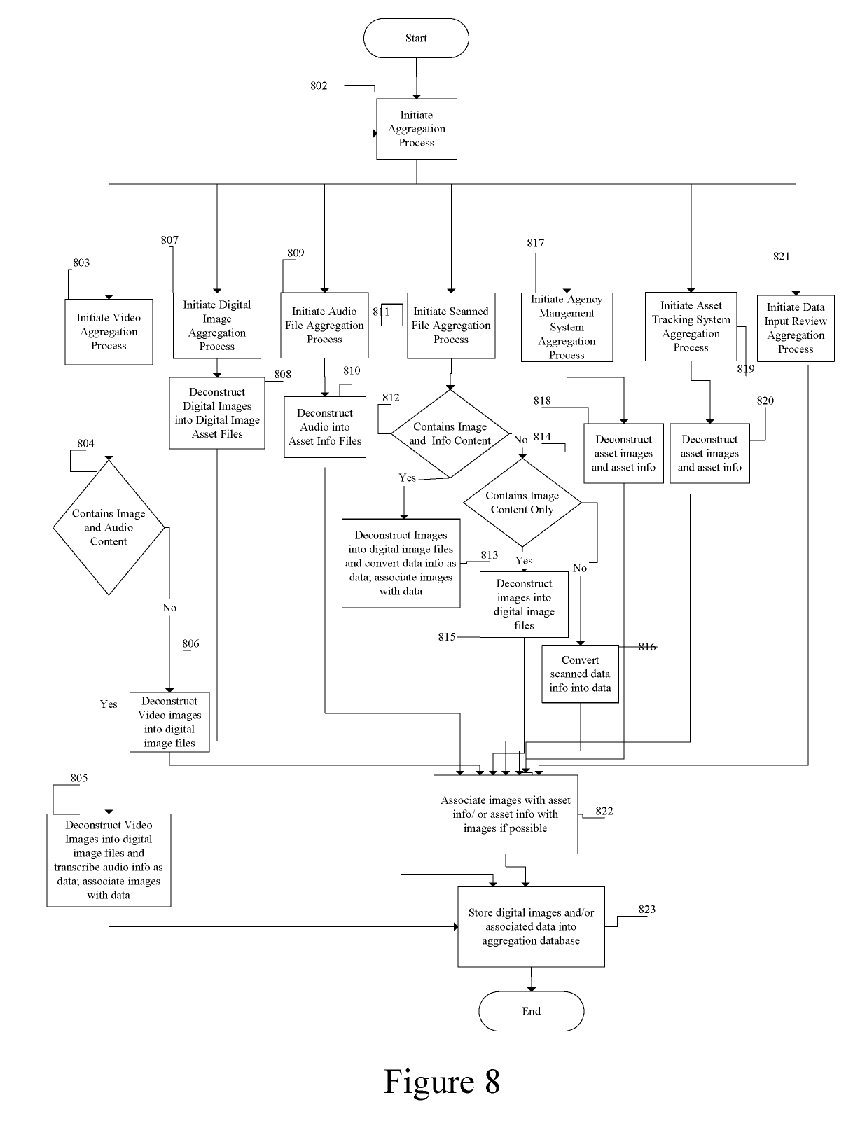

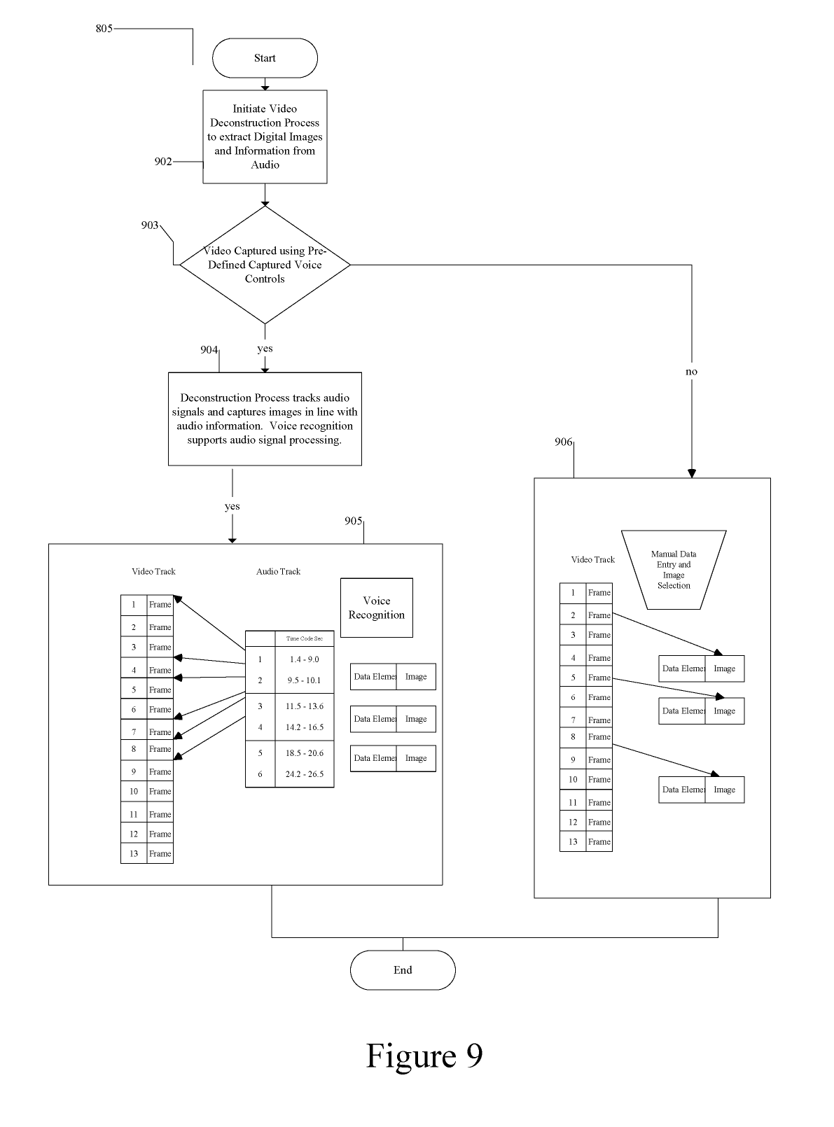

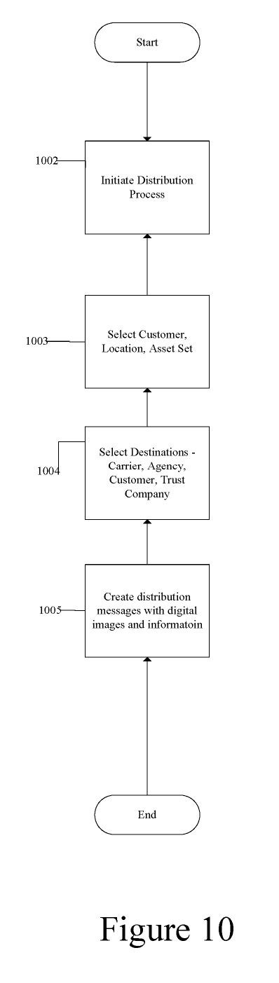

Acquisition Methods As shown in FIG. 7 the first method embodiment for electronically receiving, aggregating and distributing asset information in digital format for electronically creating, filing and approving applications for insurance coverage.

The method begins by initiating the acquisition processes 702. The processes are started for automatic system operations in the background.

The first sub method that is initiated is the module to receive video files 703. The method receives the video files from multiple sources and stores the files into data 708 in the form received. Information about the source, the date and time of receipt, and other processing information is stored along with the file.

A subsequent module is initiated to receive digital image files 704. This supports the receipt of digital files from a direct source (e.g. usb port, reader card, external designated source). The image files are received along with the information about the source, data, time and any additional information that is sent with the file. The receipt of these files may use standard image receipt programs that are readily available (e.g. Adobe's Photoshop) for image receipt or the files may be received as part of a communication program. The files are then stored in the acquisition database 708.

The module that receives audio files 705 is initiated to receive files from audio ports, remote audio designations, or as audio files that are transmitted. The files are stored on the acquisition database 708 along with information on the source, the date, time, and any other information that is provided.

A module that receives scanned files 706 is also initiated to receive scanned files from a scanner directly connected, from remote scanners, or scanned images that are received an sent via alternate means of communications. The scanned image files are stored along with any additional information including the source, the date, and the time into the acquisition database 709.

The module that receives asset information from Agency Management Systems 707 is also initiated. This establishes receipt solutions that work with the existing Agency Management Systems and adheres to the information transmission protocol and format established by the particular AMS systems. In some cases, the messaging solutions will be in accordance with the Acord XML messaging standard, and in other instances the solutions are customized for that Agency Management System. After receiving the information through this module, the information is stored in the acquisition database 708.

The module that receives asset information from Asset Tracking Systems 708 is also initiated. This establishes receipt solutions that work in conjunction with existing Asset Tracking Systems and adheres to the information transmission protocol and format established by the particular Asset Tracking System. In some cases, the messaging solutions will be based on a predefined xml message structure defined by the Asset Tracking System and in other cases the information will be received from a customized interface. After receiving the information through this module, the information is stored in the acquisition database 708.

The module that receives data and messages 708 is also initiated in this sub method. The module receives data through customized message interfaces built on top of standard messaging solutions (e.g. JMSX®) or receives messages using commercial messaging products (e.g. IBM WebSphere® MQSeries®). The module receives the data or messages and stores them along with source, date, time and any other information to the acquisition database. 709.

An additional module 708 supports direct data entry by a user into web browser based screens. This allows users to enter information about assets, as well as upload digital image files, audio files, scanned files, or video files for further process. The data is received from the user and put into the acquisition database 709.

Aggregation Method

The first sub module in this method is the module that initiates the video aggregation process 803. The video process pulls the video files from the acquisition database and initiates the video analysis process. The video file is analyzed to determine if it contains both image and audio content or if it only contains image content. If the video file contains both images and audio content then a deconstruction process 805 starts to extract the images from the video file and the associated data captured in the audio portion of the video file. The video deconstruction process is further described in FIG. 9. If the video file only contains image content then the video images are extracted from the video file, associated with data in the aggregating database, if available, and subsequently, stored in the aggregation database.

The second sub module initiates the digital image aggregation process 807. The digital images are extracted 808, associated with any existing asset information 822, and stored into the aggregation database 823.

The scanned image aggregation processes 811, reads the scanned images that were stored in the scanned image acquisition process 723. The scanned image is first analyzed to determine if it contains image and information content. 814. If the scanned image contains both, then digital asset images are extracted from the file and the data associated with the images are also extracted from the file 813.

If the scanned image does not contain both image and information then the scanned image is analyzed to determine if it contains only images 814. If the scanned image only contains asset images then the scanned image file is deconstructed into digital asset images 815, any data that can be associated with images is identified 822, and the digital images are stored along with the associations to the associated data in the aggregation database 823. If the scanned image only contains data information then the information about the digital asset is extracted from the scanned file 816, associated with image or data information in the aggregation database 822, and stored in the aggregation database 823.

The agency management system aggregation process 817 is initiated to read information received from agency management system that is stored in the acquisition database. The information is deconstructed as images and asset information, and then associated with image and asset information that is already stored in the aggregation database. The information is subsequently stored in the aggregation database. The Asset tracking system aggregation process is The data/messaging aggregation module processes the information received from external sources through messaging or customized data interfaces. The data read from the acquisition database and deconstructed into images and/or data with asset information. The data is then associated with other asset information and stored into the aggregation database.

Video Deconstruction Process FIG. 9 shows a breakdown of the video deconstruction process. The process is started by initiating video construction 902. The decision point 903 analyzes if the video was captured using pre-defined captured voice controls then the automated video deconstruction process is initiated. The deconstruction process tracks audio and captures the images in line with the audio information 904. The process in 905 shows how the digital images are extracted from the video track as the audio track is analyzed with voice recognition where the associated data is extracted. The process in 906 shows the manual process of reviewing and extracting images from the video and entering data manually.

Digital Asset Information Distribution Method

As shown in FIG. 10 the method starts by initiating the distribution process 1002. After the process has been initiated, the asset set selection process 1003 selects the asset set via a remote query process or from a user interface. The asset set selection is based on criteria submitted by the process or the user based on customer, location, type of asset, etc. Then the destination for the asset information is selected 1004. The destination may be an insurance carrier, an agency, a customer, a trust company, or any type of entity that needs to receive the asset information. The asset distribution process 1005 then creates the messages containing the asset information with images and associated data descriptions. These messages are transmitted to the destination based on the type of receiving process that the receiver has designated. This may be a messaging service capable of receiving an xml message, in which case the message will be constructed using a predefined dtd, or the information may be sent in a customized message defined by the receiver.

1. A method for processing asset information from multiple sources in preparation for digital distribution. The method comprisng the step of:
receiving and processing video containing images and data for assets
receiving and processing video containing images of assets only
receiving and processing digital images receiving and processing audio files with information on assets
receiving and processing scanned forms with asset images and data
receiving and processing asset information from agency management systems
receiving and processing asset information from asset tracking systems
receiving and processing asset information from data and/or messaging interfaces
receiving and processing asset informatoin from user input into screens

2. The method of [claim Reference], further comprising the step of aligning the asset information that was received and process from a different source

3. The method of [claim Reference], further comprising the step of processing video images using decsontruction to derive the asset images and associated data from the video file using automated and manual processes

4. The method of [claim Reference], wherein the step of generating the information required for insurance application processsing from the receipt of asset information

5. The method of [claim Reference] wherein the step of receiving information from existing asset mangement systems and supplementing with data and images for application processing

6. The method of [claim Reference], wherein the step of receiving information from agency management system and supplement with images and data for application processing

7. The method of [claim Reference], wherein the asset information is gathered from multiple sources and processed into standard data descriptive sets

8. A method for distributing asset information containing digital images and associated data for insurance and financial analysis.

9. The method of [claim Reference] wherein the asset set containing assets based set criteria including owner, location, type of asset are selected

10. The method of [claim Reference], wherein the distribution destination of the asset set is selected

11. The method of [claim Reference], wherein the asset information is formulated based on the format and interface defined by the receiver

12. A system for electronically processing asset information received from multiple sources and distributing the information in digital format to insurance and financial institutions
interface modules for receiving video files with asset information
interface modules for receiving digital image files with asset information
interface modules for receiving audio files with asset information
inteface modules for receiving scanned files with asset information
inteface modules for receiving data from user interface screens
interface module for receiving data from messaging interfaces
inteface module for receiving data from wireless transmissions
interface modue for receiving asset data from agency mangement systems
interface module for receiving asset data from asset tracking systems

13. The system of asset information processing using information received from multiple sources.

14. The system of [claim Reference]where the module supports the video deconstruction process

15. The system [claim Reference] where the module supports the image alginment process

16. The system of asset information distribution
